(19) United States
(12) Patent Application Publication
(10) Pub. No.: US 2024/0416293 A1
(43) Pub. Date: Dec. 19, 2024

(54) Device for Reintroducing Vapour Into a Volatile Liquid

(71) Applicant: GBA Marine AS, Kolbjørnsvik (NO)

(72) Inventors: Rune Bø, Arendal (NO); Helge K. Aasen, Kolbjørnsvik (NO)

(21) Appl. No.: 18/728,158

(22) PCT Filed: Jan. 10, 2023
(86) PCT No.: PCT/NO2023/050002

§ 371 Date: Jul. 11, 2024

(30) Foreign Application Priority Data
Jan. 12, 2022 (NO) 20220042

(51) Int. Cl. B01F 23/2326; B01F 25/31; B01F 25/431

(52) U.S. Cl. CPC B01F 23/2326; B01F 25/31; B01F 25/431; B01F 2215/0427

(57) ABSTRACT

Device for reintroducing vapour into a volatile liquid includes a tank for volatile liquid, a circulation pump and connected conduit for pumping liquid from the tank through a mixing zone or device for mixing vapour and liquid, and a conduit for conveying vapour from a space above the liquid level to the mixing zone or device. The mixing zone or device is arranged in a manner that ensures a pressure therein that is independent of the liquid level within the tank.

### BACKGROUND

The disclosed embodiments concern a device for reintroduction/absorption of vapours from volatile liquids, in particular reintroducing oil vapour into oil in cargo tanks on tank ships.

During transportation of volatile and flammable fluids such as oil in large tanks on tank ships, vapour is emitted from the oil, and may generate a loss of cargo if not being captured and/or reintroduced into the oil. It furthermore involves a risk of fire or explosion since such vapours are highly flammable.

These vapours would establish equilibrium with the corresponding components in the liquid phase under formation of a certain overpressure in the tank. Unfortunately, the pressure required to reach such equilibrium is higher than the current tank design pressure of oil tankers, and it's not practical or economically feasible to create a ship design that can meet this pressure requirement. Generally, vapours released from the oil cargo are denoted “Volatile Organic Compounds” (or VOC).

Many attempts have been made to overcome the above-mentioned problem in different ways. Norwegian patent No. 316 045, U.S. Pat. Nos. 6,786,063 and 3,003,325 describe systems and devices using equipment arranged outside a storage tank, while Norwegian patent Nos. 315 293 and 315 417 describe systems embedded in the tanks. A more recent solution is described in WO 2007086751 A1.

Lack of efficiency when oil level in the cargo tanks is low or moderate is a common disadvantage of the prior art systems, which need almost full tanks to function optimally. Still, there is a need for improvement in this technical field to further reduce loss and improve safety in relation to transportation of oil in oil tankers.

### SUMMARY

Provided herein is a device for absorption of vapours from volatile liquids that is efficient, inexpensive and eliminates the disadvantages inherent on existing solutions. The device should be easy to build, simple to maintain and easy and inexpensive to operate.

In specific embodiments, the disclosure concerns a method for reintroducing into oil, oil vapours which have evaporated from oil in cargo tanks of oil tankers.

A key advantage of the disclosed embodiments is inherent in the fact that reintroduction of vapours into the volatile liquid takes place at a pressure applied by a column of volatile liquid that is maintained independently of the liquid level in any tank to which the device is connected.

The vertical and the horizontal columns included in different embodiments may be arranged with an orientation that deviates somewhat from exact vertical and exact horizontal respectively.

In the further description the terms “volatile liquid”, “liquid” and “oil” are used interchangeably, the meaning being, unless otherwise specifically indicated, the liquid form of the volatile liquid referred to in the enclosed claims.

### BRIEF DESCRIPTION OF THE DRAWINGS

Below, the present invention is described in further detail in the form of non-limiting embodiments illustrated by the enclosed drawings, in which:

FIG. 1A is a diagram of a first embodiment at an early stage of cargo tank filling;

FIG. 1B is a diagram similar to FIG. 1 at a later stage of cargo tank filling;

FIG. 2 is a diagram of a second embodiment.

FIG. 3 is a side sectional view of a component of FIG. 2.

FIG. 4 is a side sectional view of an assembly of two components of FIG. 2.

FIG. 5 is a side sectional view of an alternative component to the one of FIG. 3.

FIGS. 6A and 6B show an embodiment which includes a variant of the component shown in FIG. 5.

### DETAILED DESCRIPTION

The disclosed embodiments utilize a system, such as for example a device according to WO 2007086751 A1, to reintroduce volatile vapours into the liquid used as absorption medium. Other embodiments of such reintroduction systems can include a fan, pump, or compressor, preferably in combination with a micro-bubble generator, for the gas supply and a pump to circulate the absorption medium liquid through the column. For simplicity, an ejector-based mixing device (similar to the one of WO 2007086751 A1) is used as main example for all disclosed embodiments described in this document. This device is henceforth referred to as a “mixing device”.

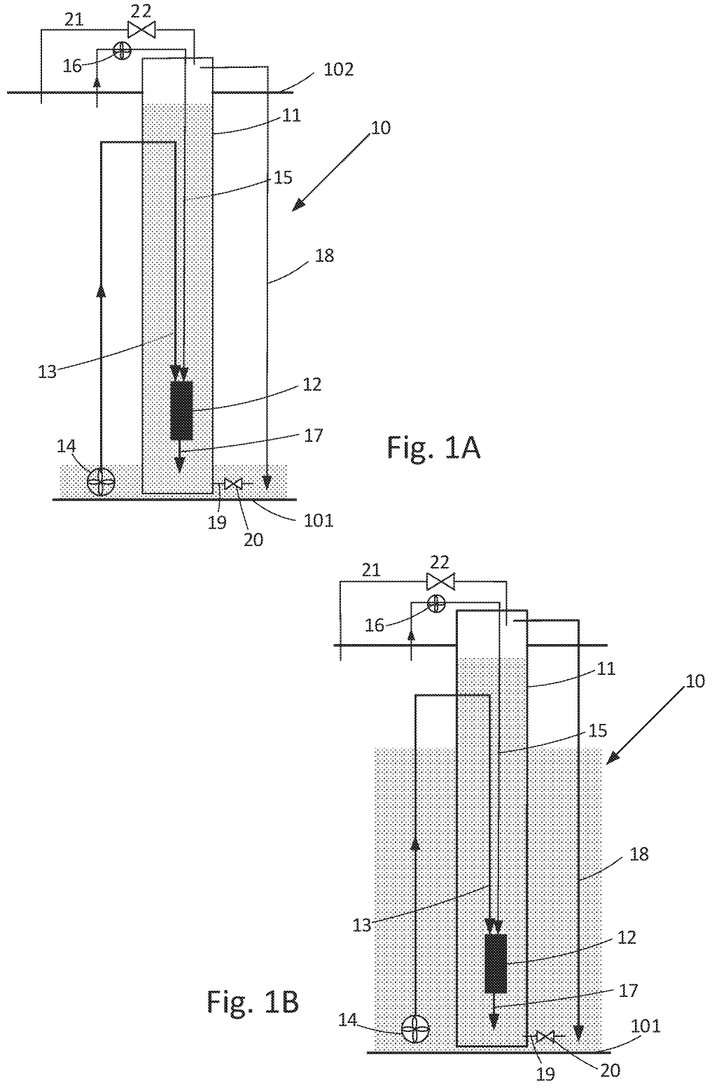

FIG. 1A shows a part of a tank 10 with a bottom wall 101 and a top wall 102. In the tank, a vertical liquid-tight tube or column 11 is arranged. A mixing device 12 is arranged proximate the bottom of said vertical column. The mixing device 12 is arranged to be charged with oil 13 provided by a pump 14 from a position proximate the tank bottom 101, and use the oil flow 13 to extract vapour 15 from a space above the liquid. The flow of vapour 15 may be assisted by a non-mandatory pump, fan or compressor 16.

While the space above the liquid from which volatile vapours are extracted is typically a space within a tank, it may also be from within any space or conduit into which vapour has been directed after vaporization.

The combined flow 17 of liquid and entrained vapour bubbles leaves the mixing device 12 proximate the bottom of the column 11, where pressure of the liquid above will condensate bubbles to liquid. The mixing unit (assuming an ejector-based device) should be positioned in a way that leads the jet flow from the outlet down towards the bottom of the column 11, and with a maximum distance from the bottom that is sufficiently small to enable the jet flow to transport the entrained gas bubbles all the way to the bottom. Recommended distance from mixing unit outlet to bottom plate will depend on flow velocity, but is typically in the range 2-5 m. Other types of mixing units, e.g., a micro-bubble generator, should be placed at or proximate the bottom of the column 11 to ensure that the maximum available hydrostatic pressure is utilized for efficient condensation of the gas bubbles.

The function of the vertical column 11 is to rapidly achieve a pressure at the mixing device 12 at least similar to that of a full cargo tank even when the tank is less than full, and even almost empty. A conduit 18 is arranged to direct oil from top of the column to the surrounding cargo tank without splashing, even when the tank is almost empty. In FIG. 1A the cargo tank is only filled to a level less than 10%, but the desired conditions with regard to pressure in the mixing device is still obtained.

For operational purposes, column 11 is equipped with an outlet 19 proximate bottom of the column. An isolation valve 20 on the outlet 19 is closed when pump 14 is running and the system is in operation, but can be opened to gravity drain the column 11 when tank 10 is emptied. To avoid under-pressure in the column 11 during gravity drain, a conduit 21 is connecting the top of the column to top of tank 10 when valve 22 is open. Gas from tank 10 can then flow into the column and replace the liquid. Valve 22 is closed when pump 14 is running, and the system is in operation.

FIG. 1B shows the same configuration at a stage in which the cargo tank is filled to a higher level, a level of about 75%. The conditions in terms of pressure at the mixing device remains unchanged and is unconditional of the level of oil in the cargo tank, only conditional upon the level of oil in the vertical column.

While the vertical column 11 is shown arranged physically within a tank 10, it is also possible to arrange the column outside the tank but fluidly connected to the tank in the manner generally taught by the above description.

Generally speaking, the arrangement of the mixing device 12 in the liquid-tight vertical column 11 filled with liquid to a level independent of the level within the tank 10, ensures a desired pressure in the mixing device independent of the liquid level in the tank 10.

Assuming an ejector-based mixing unit similar to the one of WO 2007086751 A1, the mixing device 12 outlet is typically arranged at a height 2-5 meters above the bottom of the liquid-tight vertical column 11. In this case the mixing device 12 outlet also has a centre axis, which is typically aligned with the column 11 centre axis, said outlet pointing vertically down towards the bottom of the column 11. For other methods to reintroduce volatile vapours into the liquid used as absorption medium, it may be more beneficial to arrange the mixing/gas introduction unit proximate bottom of the vertical column 11 to optimize available absorption pressure.

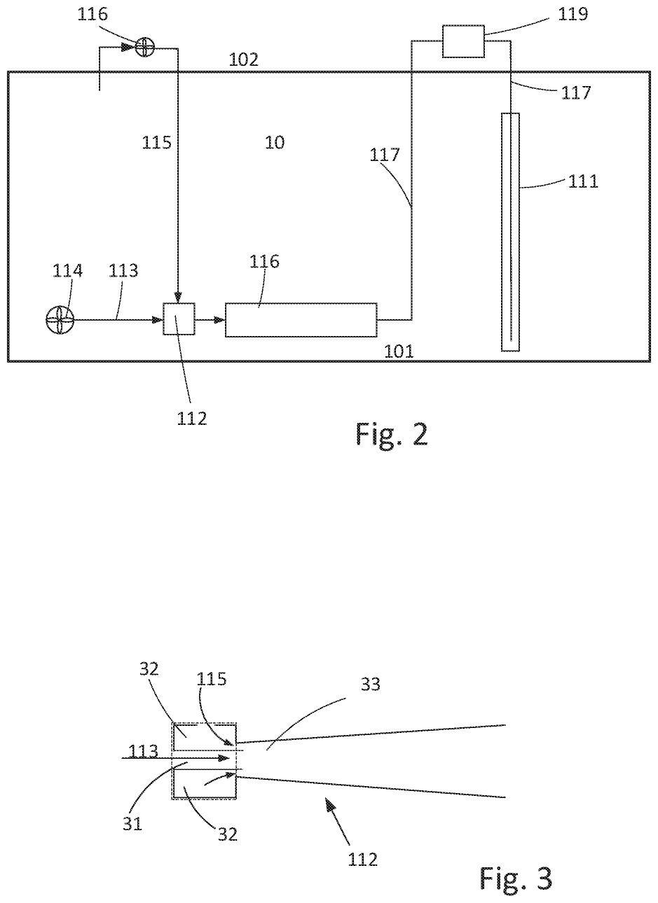

FIG. 2 shows an embodiment rather different from the one of FIGS. 1A and 1B while still obtaining the same general advantages of pressure at the outlet of the mixing device 112, which is arranged proximate the bottom wall 101 of the tank. The mixing device 112 is arranged to be charged with oil 113 provided by a pump 114 from a position proximate the tank bottom 101, and use the oil flow 113 to extract vapour 115 from a space above the liquid.

A combined flow of liquid and entrained vapour bubbles from the mixing device 112 enters a horizontal column 116 extending substantially horizontally along the bottom wall 101. The column outlet is attached to a conduit 117 that runs to a position close to or preferably above the top wall 102 of the tank. Since in operation the conduit 117 will be filled with oil, pressure inside the horizontal column will be determined by the vertical extent of conduit 117. An optional gas separation unit 119 may be arranged at or near the top of conduit 117 to remove remaining gas bubbles if for some reason not all is absorbed in the oil, after which conduit 117 continues to a position low in the tank 10, optionally through a dropline 111, not described in further detail here.

The proposed arrangement allows the vapour bubbles an extended period of time in intimate mixing with the liquid at an elevated pressure compared to the first embodiment, and thereby also an enhanced mass transfer (condensation) from vapour to liquid. Generally, parameters of interest for the efficiency of this second embodiment are the resulting pressure from conduit 117, diameter and length of the horizontal column 116 after the mixing device, volume rate of flow per cross-sectional area and resulting residence time at elevated pressure downstream of the mixing device 112.

The above-described arrangement with reference to FIG. 2, ensures a desired pressure in the mixing device 112, a pressure that is independent of the liquid level in the tank 10 and typically at least equals the pressure of a tank full of oil.

The mixing device 112 may be arranged separately from the horizontal column 116 or combined with column 116, forming an integral unit therewith.

As for the arrangement described in FIG. 1, an outlet proximate bottom of the column 116 and gas supply conduit from top of tank 10, both equipped with isolation valves, are recommended for gravity drain of the system.

FIG. 3 is a sectional side view of a mixing device 112 in the form of an ejector, useful in the present device. This mixing device may be similar to the one described in WO 2007086751 A1. The mixing device 112 has an inlet to the left in the form of a through opening 31 through which liquid oil 113 is charged, providing a driving force for the ejector when moving from left to right at considerable speed. Vapour enters the mixing device laterally as flow 115, into an annular space 32 surrounding the through opening 31, the vapour thereby being sucked into the liquid flow due to a suction force generated by the moving liquid. The annular opening between space 32 and the tube section 33 may optionally include static vane blades to create a helical flow. An advantage of such a helical flow is an improved distribution of vapour bubbles in the liquid stream.

A possible disadvantage of the second embodiment is the tendency for vapour bubbles to accumulate at the uppermost part of the horizontal absorption column 116 due to density difference between liquid and vapour, which may lead to a merger of the many fine bubbles to fewer, larger bubbles, and thereby a reduction of the contact area between vapour and liquid.

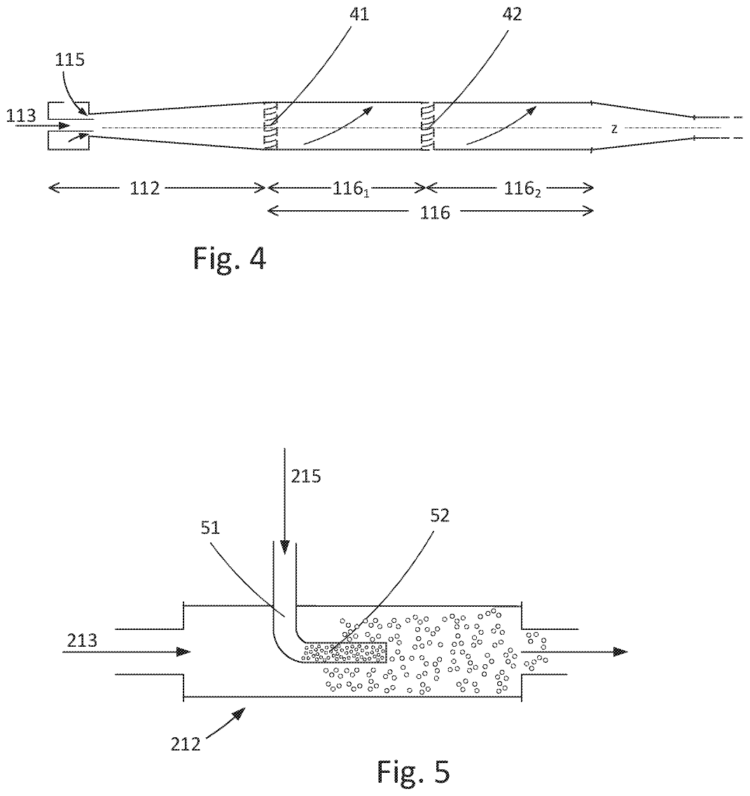

This potentially negative effect can be counteracted by inserting one or more sections containing curved or inclined vane blades 41, 42 as shown in FIG. 4. If more than one section is inserted, the horizontal column 116 will be divided into multiple segments 1161, 1162 as shown in FIG. 4. While the vane blades according to FIG. 4 are arranged only at the inlet end of each section 1161 and 1162 respectively, they may be arranged anywhere in each section and even have an extension throughout the entire section(s).

An arrangement according to FIG. 4 converts a linear flow movement to a helical flow movement, providing a velocity component in a direction transversely of the axis of the column larger than the effect of the ascending force on the bubbles caused by the density difference between liquid and vapour. An added feature of such rotational flow is the outwards gravity effect, bringing the heavier liquid outwards in the horizontal column 116 and the lighter vapour inwards to the centre of the column. It should be noted that reference numeral 116 is used as a common referral to a single horizontal column 116 and columns consisting of a plurality of horizontal column sections such as column sections 1161 and 1162. The horizontal column 116 shown in FIG. 4 have a length axis z.

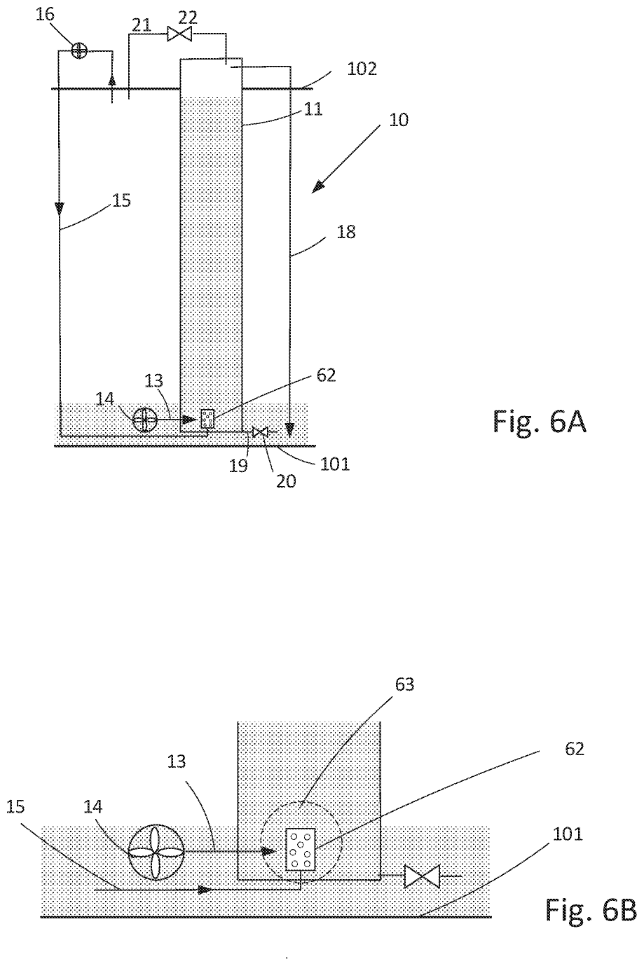

FIG. 5 is a side sectional view of a mixing device 212 using a principle different from that of the mixing device 112 of FIG. 3. The liquid flow 113 enters the mixing device from the left while the vapour flow 115 enters the mixing device through a pipe 51 exhibiting a perforated section 52 within the mixing device, causing the vapour to be entrained in the liquid flow as small bubbles. Though not shown in FIG. 5, horizontal column sections 116 will be arranged downstream of mixing device 212 in a similar manner to what is shown in FIG. 4. FIG. 6A shows a variant of the device shown in FIG. 5 in an embodiment arranged within a vertical column 11 of the kind shown in FIGS. 1 and 2. In such a case, there is no need for a housing like 212 in FIG. 5, and the conduit 15 conveying vapour from the top of the tank is simply arranged with a perforated end section or perforated box 62, serving the same purpose as the perforated section 52 shown in FIG. 5, to spread the vapour bubbles in the oil to thereby entrain the vapour in the oil causing the vapour to condense. The pump 14 pumps oil in direction of the perforated section or box 62 to enhance the effect of entraining and condensing the vapour in the oil.

FIG. 6B is an enlarged view of the lower part of vertical column 11 and surroundings in FIG. 5, illustrating a mixing zone 63 illustrated as a circle, in which vapour bubbles from the perforated box 62 meets the oil into which it is entrained. Naturally, there are no exact boundaries for this zone.

All embodiments described herein may beneficially be combined with other devices that are not necessarily part of the invention, such as dropline devices arranged to reduce evaporation from volatile liquids during tank filling, or gas-liquid separators to remove any remaining gas bubbles from the liquid before it is re-introduced into the cargo tank.

1-13. (canceled)

14. A device for reintroducing vapor into a volatile liquid, comprising:
a tank (10) for volatile liquid;
a circulation pump (14) and connected conduit (13, 113, 213) configured to pump liquid from the tank (10) through a mixing zone or device (12, 112, 212) for mixing vapor and liquid; and
a conduit (15, 115, 215) for conveying vapor from a space above a liquid level to the mixing zone or device (12, 112, 212), wherein
the mixing zone or device (12, 112, 212) is configured to ensure a pressure therein that is independent of the liquid level within the tank (10).

15. The device as claimed in claim 14, wherein the mixing device (12) is positioned within a liquid-tight vertical column (11) filled with liquid to a level independent of the level within the tank (10), thereby ensuring the desired pressure.

16. The device as claimed in claim 15, wherein the mixing device (12) is arranged less than 5 meters from a bottom of the vertical column (11), said column being arranged within the tank (10) and exhibiting an upper end in fluid communication (18) with an inner volume of the tank (10).

17. The device as claimed in claim 16, wherein the mixing device (12) is arranged between 2 meters and 5 meters from the bottom of the vertical column (11).

18. The device as claimed in claim 14, wherein the mixing device (12) has an outlet with a central axis aligned with the central axis of the column, said outlet pointing downward toward a bottom of the vertical column (11).

19. The device as claimed in claim 15, wherein the mixing device (12) has an outlet with a central axis aligned with the central axis of the column, said outlet pointing downward toward a bottom of the vertical column (11).

20. The device as claimed in claim 14, wherein
the mixing device (112, 212) is arranged proximate the bottom (101) of a tank (10) and has an outlet connected to a horizontal column (116) arranged proximate the bottom (101) of the tank (10),
the horizontal column (116) is connected to a conduit (117) that runs upwards to an elevation higher than the elevation of the mixing device (112, 212) and independent of the liquid level in the tank (10), thereby ensuring the desired pressure.

21. The device as claimed in claim 20, wherein the mixing device (112, 212) is arranged separately from the horizontal column (116).

22. The device as claimed in claim 20, wherein the mixing device (112, 212) is combined with a horizontal column (116) forming an integral unit therewith.

23. The device as claimed in claim 20, wherein the horizontal column (116) includes one or more sections containing a plurality of static vane blades (41, 42) configured to induce a swirl in the flow entering the horizontal column (116).

24. The device as claimed in claim 21, wherein the horizontal column (116) includes one or more sections containing a plurality of static vane blades (41, 42) configured to induce a swirl in the flow entering the horizontal column (116).

25. The device as claimed in claim 22, wherein the horizontal column (116) includes one or more sections containing a plurality of static vane blades (41, 42) configured to induce a swirl in the flow entering the horizontal column (116).

26. The device as claimed in claim 23, wherein the vane blades (41, 42) are inclined in relation to a longitudinal axis (z) of the horizontal column (116), curved in their longitudinal extension, or both.

27. The device as claimed in claim 20, comprising a gas separation unit (119) arranged on the conduit (117) from the horizontal column (116).

28. The device as claimed in claim 23, comprising a gas separation unit (119) arranged on the conduit (117) from the horizontal column (116).

29. The device as claimed in claim 26, comprising a gas separation unit (119) arranged on the conduit (117) from the horizontal column (116).

30. The device as claimed in claim 20, wherein the conduit (117) from the horizontal column (116) terminates in a dropline (111).

31. The device as claimed in claim 20, wherein
the conduit (15) is configured to convey vapor to a perforated end portion or box (62) arranged at the bottom of the vertical column (11), and
the conduit (13) is configured to pump liquid to a zone (63) surrounding said end portion or box (62).

32. The device as claimed in claim 14, wherein the device is configured to maintain an overpressure of at least 1 bar compared to ambient pressure.

33. The device as claimed in claim 32, wherein the device is configured to maintain an overpressure of at least 2 bar compared to ambient pressure.
